(19) United States
(12) Patent Application Publication
(10) Pub. No.: US 2015/0081981 A1
(43) Pub. Date: Mar. 19, 2015

(54) GENERATING PREDICTIVE CACHE STATISTICS FOR VARIOUS CACHE SIZES

(71) Applicant: NetApp, Inc., Sunnyvale, CA (US)

(72) Inventors: Brian D. McKean, Longmont, CO (US); Donald R. Humlicek, Wichita, KS (US)

(73) Assignee: NetApp, Inc., Sunnyvale, CA (US)

(21) Appl. No.: 14/031,999

(22) Filed: Sep. 19, 2013

(51) Int. Cl. G06F 12/12

(52) U.S. Cl. CPC G06F 12/123
USPC 711/136; 711/133

(57) ABSTRACT

Technology is disclosed for generating predictive cache statistics for various cache sizes. In some embodiments, a storage controller includes a cache tracking mechanism for concurrently generating the predictive cache statistics for various cache sizes for a cache system. The cache tracking mechanism can track simulated cache blocks of a cache system using segmented cache metadata while performing an exemplary workload including various read and write requests (client-initiated I/O operations) received from client systems (or clients). The segmented cache metadata corresponds to one or more of the various cache sizes for the cache system.

### FIELD OF THE INVENTION

At least one embodiment of the disclosed technology pertains to data storage systems, and more particularly to concurrently generating predictive cache statistics for various cache sizes.

### BACKGROUND

A network storage controller is a processing system that is used to store and retrieve data on behalf of one or more hosts on a network. A storage controller operates on behalf of one or more hosts to store and manage data in a set of mass storage devices, e.g., magnetic or optical storage-based disks, solid state devices, or tapes. Some storage controllers are designed to service file-level requests from hosts, as is commonly the case with file servers used in network attached storage (NAS) environments. Other storage controllers are designed to service block-level requests from hosts, as with storage controllers used in a storage area network (SAN) environment. Still other storage controllers are capable of servicing both file-level requests and block-level requests, as is the case with various storage controllers made by NetApp, Inc. of Sunnyvale, Calif.

With the advent of solid state cache systems, and flash-based cache systems in particular, the size of cache memory that is utilized by a storage controller has grown relatively large, in many cases, into Terabytes. Furthermore, conventional storage systems are often configurable providing for a variety of cache memory sizes. Typically, the larger the cache size, the better the performance of the storage system. However, cache memory is expensive and performance benefits of additional cache memory can decrease considerably as the size of the cache memory increases, e.g., depending on the workload.

Currently, some storage systems offer the ability to simulate a specified cache size and gather limited predictive statistics for a particular simulated cache size. Unfortunately, the simulations can be extremely time consuming and must be run numerous times to determine predictive cache statistics for different cache sizes.

Therefore, the problems of multiple configurations and excessive time consumption pose a significant challenge when determining an appropriate cache size for a storage system.

### BRIEF DESCRIPTION OF THE DRAWINGS

One or more embodiments are illustrated by way of example and not limitation in the figures of the accompanying drawings, in which like references indicate similar elements.

FIG. 1 is a block diagram illustrating an example of a network storage system including cache block metadata for generating predictive cache statistics for various cache sizes.

FIG. 2 is a block diagram illustrating an example of a storage controller that can implement one or more network storage servers.

FIG. 3 is a schematic diagram illustrating an example of the architecture of a storage operating system in a storage server.

FIGS. 4A and 4B are block diagrams illustrating technology for tracking a simulated secondary cache system using cache block metadata stored on a primary cache system.

FIG. 5 is a block diagram illustrating technology for tracking a simulated secondary cache system using cache block metadata stored on a primary cache system.

FIG. 6 is a flow diagram illustrating an example process for generating predictive cache statistics for various cache sizes.

FIG. 7 is a flow diagram illustrating an example process for tracking a workload to determine cache statistics for various cache sizes.

FIG. 8 is a flow diagram illustrating an example cache miss process for generating predictive cache statistics for various cache sizes.

FIG. 9 is a flow diagram illustrating illustrates an example cache hit process for generating predictive cache statistics for various cache sizes.

FIGS. 10A and 10B are block diagrams illustrating example operation of a least recently used cache tracking mechanism with segment tracking pointers and segment identifiers added to cache block metadata prior to and after a cache hit.

FIGS. 11A and 11B are block diagrams illustrating example operation of a least recently used cache tracking mechanism with segment tracking pointers and segment identifiers added to the cache block metadata prior to and after a cache miss.

### DETAILED DESCRIPTION

References in this specification to “an embodiment”, “one embodiment”, “some embodiments”, or the like, mean that the particular feature, structure or characteristic being described is included in at least one embodiment. Occurrences of such phrases in this specification do not necessarily all refer to the same embodiment.

As discussed above, many storage systems now implement solid state or flash-based cache systems. A storage system with a flash-based cache system provides numerous benefits over conventional storage systems (storage systems without flash-based cache systems). For example, a storage system with a flash-based cache system can: (1) simplify storage and data management through automatic staging/de-staging for target volumes; (2) improve storage cost efficiency by reducing the number of drives needed to meet performance requirements and thereby reduce overall power consumption and cooling requirements; and (3) improve the read performance of the storage system.

However, cache memory is expensive and performance benefits of additional cache memory can decrease considerably as the size of the cache memory increases depending on the workload. Additionally, the simulations can be extremely time consuming and must be run numerous times to determine predictive cache statistics for different cache sizes.

Cache tracking technology for generating predictive cache statistics for various cache sizes for a cache system is described. In various embodiments, the cache tracking mechanism (“the technology”) can track simulated cache blocks of a cache system using segmented cache metadata while performing a workload including various read and write requests (client-initiated I/O operations) received from client systems (or clients). The segmented cache metadata corresponds to one or more of the various cache sizes for the cache system.

In some embodiments, the technology augments a least recently used (LRU) based cache tracking mechanism with segment tracking pointers and segment identifiers added to the metadata structures. The segments correspond to multiple cache sizes and the described tracking mechanism tracks the maximum cache size. In some embodiments, there need not be actual cached blocks used to run the predictive cache statistics. Rather, simulated cache blocks can be used to gather the statistics through the use of the cache block metadata.

Although the examples discussed herein are primarily directed to a LRU-based cache tracking mechanism, other cache tracking mechanisms can alternatively or additionally be utilized. For example, the technology described herein can be applied to a most recently used (MRU) algorithm, a clocked algorithm, various weighted algorithms, adaptive replacement cache (ARC) algorithms, etc.

### Overview

a. System Architecture

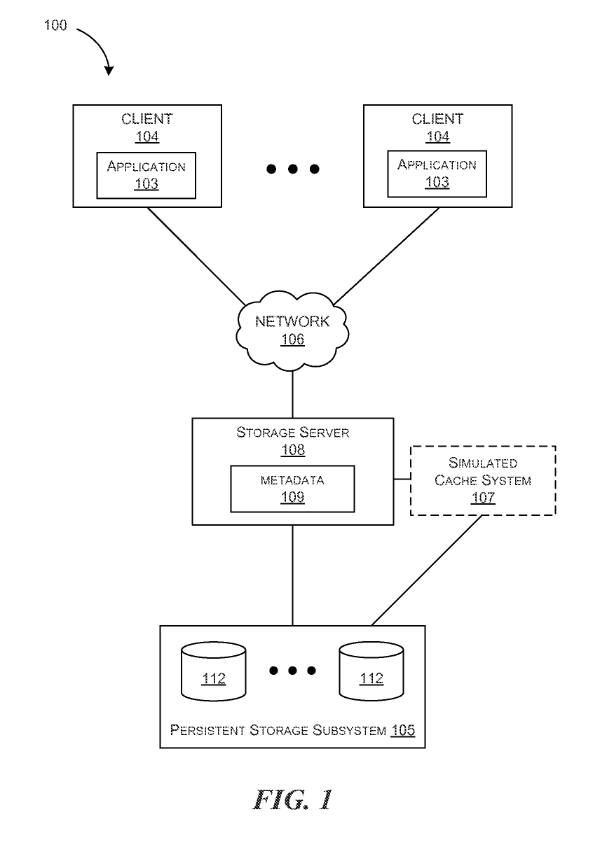

FIG. 1 is a block diagram illustrating an example network storage system 100 (or configuration) in which the technology introduced herein can be implemented. The network configuration described with respect to FIG. 1 is for illustration of a type of configuration in which the technology described herein can be implemented. As would be recognized by one skilled in the art, other network storage configurations and/or schemes could be used for implementing the technology disclosed herein.

As illustrated in the example of FIG. 1, the network storage system 100 includes multiple client systems 104, a storage server 108, and a network 106 connecting the client systems 104 and the storage server 108. The storage server 108 is coupled with a number of mass storage devices (or storage containers) 112 in a mass storage subsystem 105. Some or all of the mass storage devices 112 can be various types of storage devices, e.g., disks, flash memory, solid-state drives (SSDs), tape storage, etc. However, for ease of description, the storage devices 112 are discussed as disks herein. However as would be recognized by one skilled in the art, other types of storage devices could be used.

Although illustrated as distributed systems, in some embodiments the storage server 108 and the mass storage subsystem 105 can be physically contained and/or otherwise located in the same enclosure. For example, the storage system 108 and the mass storage subsystem 105 can together be one of the E-series storage system products available from NetApp®, Inc. The E-series storage system products can include one or more embedded controllers (or storage servers) and disks. Furthermore, the storage system can, in some embodiments, include a redundant pair of controllers that can be located within the same physical enclosure with the disks. The storage system can be connected to other storage systems and/or to disks within or outside of the enclosure via a serial attached SCSI (SAS)/Fibre Channel (FC) protocol. Other protocols for communication are also possible including combinations and/or variations thereof.

In another embodiment, the storage server 108 can be, for example, one of the FAS-series of storage server products available from NetApp®, Inc. The client systems 104 can be connected to the storage server 108 via the network 106, which can be a packet-switched network, for example, a local area network (LAN) or wide area network (WAN). Further, the storage server 108 can be connected to the disks 112 via a switching fabric (not illustrated), which can be a fiber distributed data interface (FDDI) network, for example. It is noted that, within the network data storage environment, any other suitable number of storage servers and/or mass storage devices, and/or any other suitable network technologies, may be employed.

The storage server 108 can make some or all of the storage space on the disk(s) 112 available to the client systems 104 in a conventional manner. For example, each of the disks 112 can be implemented as an individual disk, multiple disks (e.g., a RAID group) or any other suitable mass storage device(s) including combinations and/or variations thereof. Storage of information in the mass storage subsystem 105 can be implemented as one or more storage volumes that comprise a collection of physical storage disks 112 cooperating to define an overall logical arrangement of volume block number (VBN) space on the volume(s). Each logical volume is generally, although not necessarily, associated with its own file system.

The disks within a logical volume/file system are typically organized as one or more groups, wherein each group may be operated as a Redundant Array of Independent (or Inexpensive) Disks (RAID). Most RAID implementations, e.g., a RAID-6 level implementation, enhance the reliability/integrity of data storage through the redundant writing of data “stripes” across a given number of physical disks in the RAID group, and the appropriate storing of parity information with respect to the striped data. An illustrative example of a RAID implementation is a RAID-6 level implementation, although it should be understood that other types and levels of RAID implementations may be used according to the technology described herein. One or more RAID groups together form an aggregate. An aggregate can contain one or more volumes.

The storage server 108 can receive and respond to various read and write requests from the client systems (or clients) 104, directed to data stored in or to be stored in the storage subsystem 105.

Although the storage server 108 is illustrated as a single unit in FIG. 1, it can have a distributed architecture. For example, the storage server 108 can be designed as a physically separate network module (e.g., “N-blade”) and disk module (e.g., “D-blade) (not illustrated), which communicate with each other over a physical interconnect. Such an architecture allows convenient scaling, e.g., by deploying two or more N-blades and D-blades, all capable of communicating with each other through the physical interconnect.

A storage server 108 can be configured to implement one or more virtual storage servers. Virtual storage servers allow the sharing of the underlying physical storage controller resources, (e.g., processors and memory, between virtual storage servers while allowing each virtual storage server to run its own operating system) thereby providing functional isolation. With this configuration, multiple server operating systems that previously ran on individual servers, (e.g., to avoid interference) are able to run on the same physical server because of the functional isolation provided by a virtual storage server implementation. This can be a more cost effective way of providing storage server solutions to multiple customers than providing separate physical servers for each customer.

As illustrated in the example of FIG. 1, storage server 108 includes cache system metadata 109. The cache system metadata 109 can be used to implement a cache tracking mechanism for generating predictive cache statistics for various cache sizes for a cache system 107 as described herein. The cache system 107 can be, for example, a flash memory system.

Although illustrated separately, the cache system 107 can be combined with the storage server 108. Alternatively or additionally, the cache system 107 can be physically and/or functionally distributed.

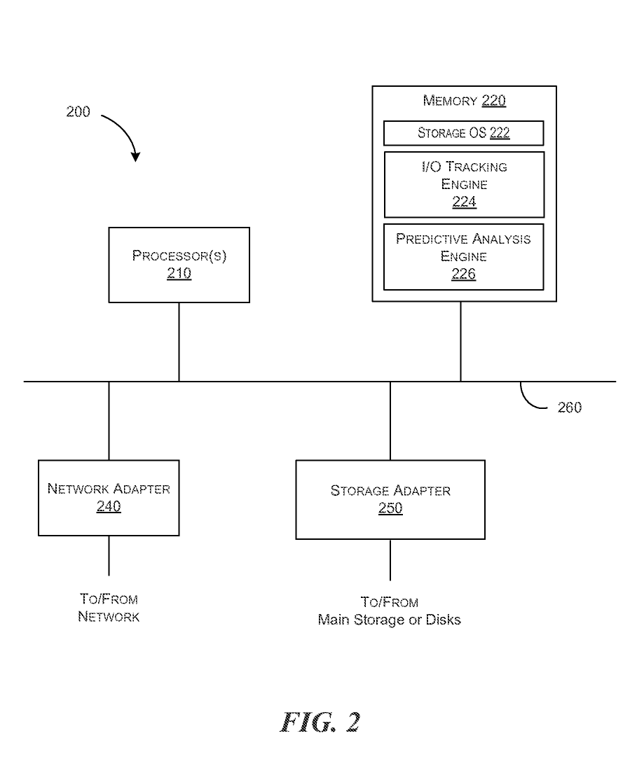

FIG. 2 is a block diagram illustrating an example of a hardware architecture of a storage controller 200 that can implement one or more network storage servers, for example, storage server 108 of FIG. 1. The storage server is a processing system that provides storage services relating to the organization of information on storage devices, e.g., disks 112 of the mass storage subsystem 105. In an illustrative embodiment, the storage server 108 includes a processor subsystem 210 that includes one or more processors. The storage server 108 further includes a memory 220, a network adapter 240, and a storage adapter 250, at least some of which can be interconnected by an interconnect 260, e.g., a physical interconnect.

The storage server 108 can be embodied as a single- or multi-processor storage server executing a storage operating system 222 that preferably implements a high-level module, called a storage manager, to logically organize data as a hierarchical structure of named directories, files, and/or data “blocks” on the disks 112. A block can be a sequence of bytes of specified length.

The memory 220 illustratively comprises storage locations that are addressable by the processor(s) 210 and adapters 240 and 250 for storing software program code and data associated with the technology introduced here. For example, some of the storage locations of memory 220 can be used to store an I/O tracking engine 224 and a predictive analysis engine 226.

The I/O tracking engine 224 can track the cache blocks of the simulated cache system 107 of FIG. 1 using a segmented cache metadata stored on the storage controller 200. More specifically, I/O tracking engine 224 can track the cache blocks of the simulated cache system 107 of FIG. 1 while performing a workload including various read and write requests (client-initiated I/O operations) received from the client systems (or clients) 104 directed to data stored in or to be stored in the storage subsystem 105. The segmented cache metadata can be initialized such that each segment of the cache metadata corresponds to one or more of multiple cache sizes providing for the ability to concurrently track the multiple potential cache sizes. In some embodiments, it is possible to simultaneously track the multiple potential cache sizes.

The predictive analysis engine 226 can determine predictive statistics and/or analysis for the multiple simulated cache sizes concurrently using the corresponding segments of the cache metadata. Additionally, the predictive statistics and/or analysis can include performance comparisons of the multiple simulated cache sizes and recommendations based on the exemplary workload.

The storage operating system 222, portions of which are typically resident in memory and executed by the processing elements, functionally organizes the storage server 108 by (among other functions) invoking storage operations in support of the storage service provided by the storage server 108. It will be apparent to those skilled in the art that other processing and memory implementations, including various other non-transitory media, e.g., computer readable media, may be used for storing and executing program instructions pertaining to the technology introduced here. Similar to the storage server 108, the storage operating system 222 can be distributed, with modules of the storage system running on separate physical resources. In some embodiments, instructions or signals can be transmitted on transitory computer readable media, e.g., carrier waves or other computer readable media.

The network adapter 240 can include multiple ports to couple the storage server 108 with one or more clients 104, or other storage servers, over point-to-point links, wide area networks, virtual private networks implemented over a public network (Internet) or a shared local area network. The network adapter 240 thus can include the mechanical components as well as the electrical and signaling circuitry needed to connect the storage server 108 to the network 106. Illustratively, the network 106 can be embodied as an Ethernet network or a Fibre Channel network. Each client 104 can communicate with the storage server 108 over the network 106 by exchanging packets or frames of data according to pre-defined protocols, e.g., Transmission Control Protocol/Internet Protocol (TCP/IP).

The storage adapter 250 cooperates with the storage operating system 222 to access information requested by clients 104. The information may be stored on any type of attached array of writable storage media, e.g., magnetic disk or tape, optical disk (e.g., CD-ROM or DVD), flash memory, solid-state drive (SSD), electronic random access memory (RAM), micro-electro mechanical and/or any other similar media adapted to store information, including data and parity information. However, as illustratively described herein, the information is stored on disks 112. The storage adapter 250 includes multiple ports having input/output (I/O) interface circuitry that couples with the disks over an I/O interconnect arrangement, e.g., a conventional high-performance, Fibre Channel link topology.

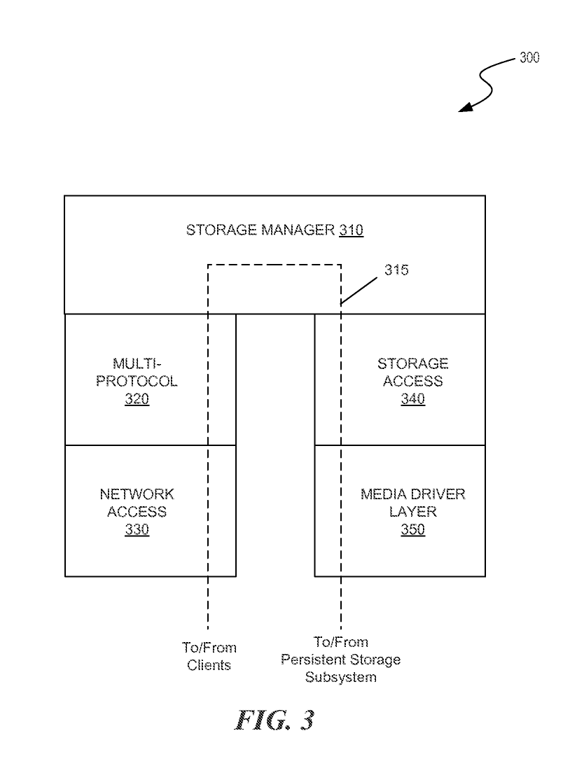

The storage operating system 222 facilitates clients' access to data stored on the disks 112. In certain embodiments, the storage operating system 222 implements a write-anywhere file system that cooperates with one or more virtualization modules to “virtualize” the storage space provided by disks 112. In certain embodiments, a storage manager element of the storage operation system 222 such as, for example storage manager 310 as illustrated in FIG. 3, logically organizes the information as a hierarchical structure of named directories and files on the disks 112. Each “on-disk” file may be implemented as a set of disk blocks configured to store information. As used herein, the term “file” means any logical container of data. The virtualization module(s) may allow the storage manager 310 to further logically organize information as a hierarchical structure of blocks on the disks that are exported as named logical units.

The interconnect 260 is an abstraction that represents any one or more separate physical buses, point-to-point connections, or both, connected by appropriate bridges, adapters, or controllers. The interconnect 260, therefore, may include, for example, a system bus, a form of Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire,” FibreChannel, Thunderbolt, and/or any other suitable form of physical connection including combinations and/or variations thereof.

FIG. 3 is a schematic diagram illustrating an example of the architecture 300 of a storage operating system 222 for use in a storage server 108. In some embodiments, the storage operating system 222 can be the NetApp® Data ONTAP® operating system available from NetApp, Inc., Sunnyvale, Calif. that implements a Write Anywhere File Layout (WAFL®) file system. However, another storage operating system may alternatively be designed or enhanced for use in accordance with the technology described herein.

The storage operating system 222 can be implemented as programmable circuitry programmed with software and/or firmware, or as specially designed non-programmable circuitry (i.e., hardware), or in a combination and/or variation thereof. In the illustrated embodiment, the storage operating system 222 includes several modules, or layers. These layers include a storage manager 310, which is a functional element of the storage operating system 222. The storage manager 310 imposes a structure (e.g., one or more file systems) on the data managed by the storage server 108 and services read and write requests from clients 104.

To allow the storage server to communicate over the network 106 (e.g., with clients 104), the storage operating system 222 can also include a multi-protocol layer 320 and a network access layer 330, logically under the storage manager 310. The multi-protocol layer 320 implements various higher-level network protocols, e.g., Network File System (NFS), Common Internet File System (CIFS), Hypertext Transfer Protocol (HTTP), and/or Internet small computer system interface (iSCSI), to make data stored on the disks 112 available to users and/or application programs. The network access layer 330 includes one or more network drivers that implement one or more lower-level protocols to communicate over the network, e.g., Ethernet, Internet Protocol (IP), TCP/IP, Fibre Channel Protocol and/or User Datagram Protocol/Internet Protocol (UDP/IP).

Also, to allow the device to communicate with a storage subsystem (e.g., storage subsystem 105 of FIG. 1), the storage operating system 222 includes a storage access layer 340 and an associated storage driver layer 350 logically under the storage manager 310. The storage access layer 340 implements a higher-level storage redundancy algorithm, e.g., RAID-4, RAID-5, RAID-6, or RAID DP®. The storage driver layer 350 implements a lower-level storage device access protocol, e.g., Fibre Channel Protocol or small computer system interface (SCSI).

Also shown in FIG. 3 is the path 315 of data flow through the storage operating system 222, associated with a read or write operation, from the client interface to the storage interface. Thus, the storage manager 310 accesses a storage subsystem, e.g., storage system 105 of FIG. 1, through the storage access layer 340 and the storage driver layer 350. Clients 104 can interact with the storage server 108 in accordance with a client/server model of information delivery. That is, the client 104 requests the services of the storage server 108, and the storage server may return the results of the services requested by the client, by exchanging packets over the network 106. The clients may issue packets including file-based access protocols, such as CIFS or NFS, over TCP/IP when accessing information in the form of files and directories. Alternatively, the clients may issue packets including block-based access protocols, such as iSCSI and SCSI, when accessing information in the form of blocks.

b. File System Structure

It is useful now to consider how data can be structured and organized in a file system by storage controllers such as, for example, storage server 108 of FIG. 1, according to certain embodiments. The term “file system” is used herein only to facilitate description and does not imply that the stored data must be stored in the form of “files” in a traditional sense; that is, a “file system” as the term is used herein can store data in the form of blocks, logical units (LUNs) and/or any other type(s) of units.

In at least some embodiments, data is stored in volumes. A “volume” is a logical container of stored data associated with a collection of mass storage devices, e.g., disks, which obtains its storage from (e.g., is contained within) an aggregate, and which is managed as an independent administrative unit, e.g., a complete file system. Each volume can contain data in the form of one or more directories, subdirectories, qtrees, files and/or files. An “aggregate” is a pool of storage that combines one or more physical mass storage devices (e.g., disks) or parts thereof into a single logical storage object. An aggregate contains or provides storage for one or more other logical data sets at a higher level of abstraction, e.g., volumes.

### Predictive Cache Statistics

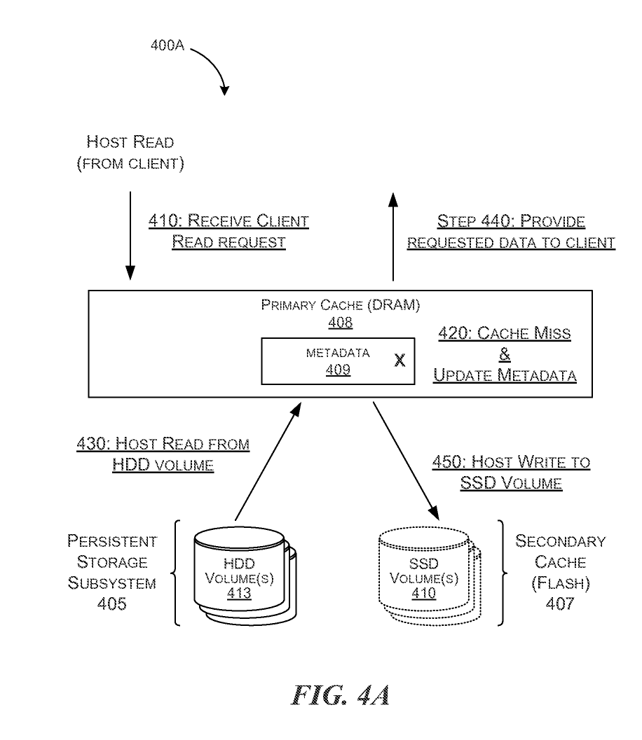

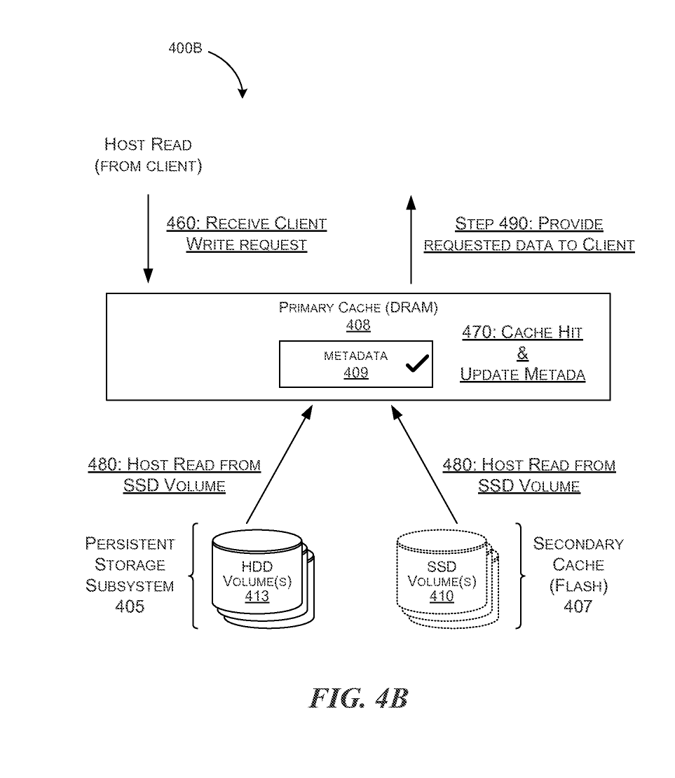

FIGS. 4A and 4B are block diagrams 400A and 400B, respectively, illustrating an example technology for tracking a simulated secondary cache system using cache block metadata stored on a primary cache system. More specifically, FIGS. 4A and 4B illustrate an example cache read miss and an example cache read hit, respectively, occurring while tracking a simulated secondary cache system 407 using segmented metadata stored on a primary cache system.

In the examples of FIGS. 4A and 4B, a storage server (not illustrated) such as, for example, storage server 108 of FIG. 1, includes a primary cache system 408 having segmented metadata 409 stored thereon for tracking simulated cache blocks of a secondary cache system 407 while performing a workload including a client-initiated read request (operation). The primary cache system 408 can be, for example, a dynamic random access memory (DRAM) and the secondary cache system 407 can be a flash read cache system including multiple SSD volumes 410.

In some embodiments, the secondary cache 407 can be, in whole or in part, simulated. That is, the segmented metadata 409 can be used to track simulated cache blocks on a secondary cache system 407 that does not exist or that includes only a fraction of the maximum supported cache size. Thus, the system can generate predictive cache statistics for various cache sizes up to a maximum supported cache size without requiring a system operator to pre-purchase and/or otherwise configure a secondary cache system 407.

The secondary cache system 407 is illustrated with a dotted-line because the storage system may be configured without a secondary cache system 407 or with a secondary cache system 407 of particular size that is less than the maximum supported (or configurable) cache size for the storage system. In such cases, the storage system may or may not use the secondary cache system 407 in performing the workload including various read and/or write requests (client-initiated I/O operations) received from client systems (or clients).

Referring first to FIG. 4A, at stage 411 a client read (or host read) request directed to data persistently stored in the persistent storage subsystem 405 is received and processed by the storage system to determine a read location or logical block address (LBA) associated with the read request from which to read requested data. Responsive to the read request, at stage 420, the storage system checks the segmented metadata 409 to determine if the read data is stored on the simulated secondary cache 407 using the read location or LBA. As discussed above, while the simulated secondary cache 407 may not exist or may only exist in part, the segmented metadata can track the maximum configurable size of the simulated secondary cache 407.

In some embodiments, the cache block metadata can comprise a linked-list data structure having multiple cache metadata blocks that each include particular LBA indicating the LBAs that are located (stored) on the simulated secondary cache 407. Thus, the storage system may traverse the cache block metadata to determine if the read location or LBA is indicated. If so, then a cache hit (or simulated cache hit) occurs and, if not, then a cache miss (or simulated cache miss occurs).

In the example of FIG. 4A, at stage 420, the storage server reads, checks, and/or otherwise traverses or interrogates the segmented metadata 409 to determine that the read location or LBA associated with the received client request is not indicated by the cache metadata and thus, a cache miss occurs. The storage system makes a record and/or otherwise records that the cache miss occurred and updates the segmented metadata 409 accordingly.

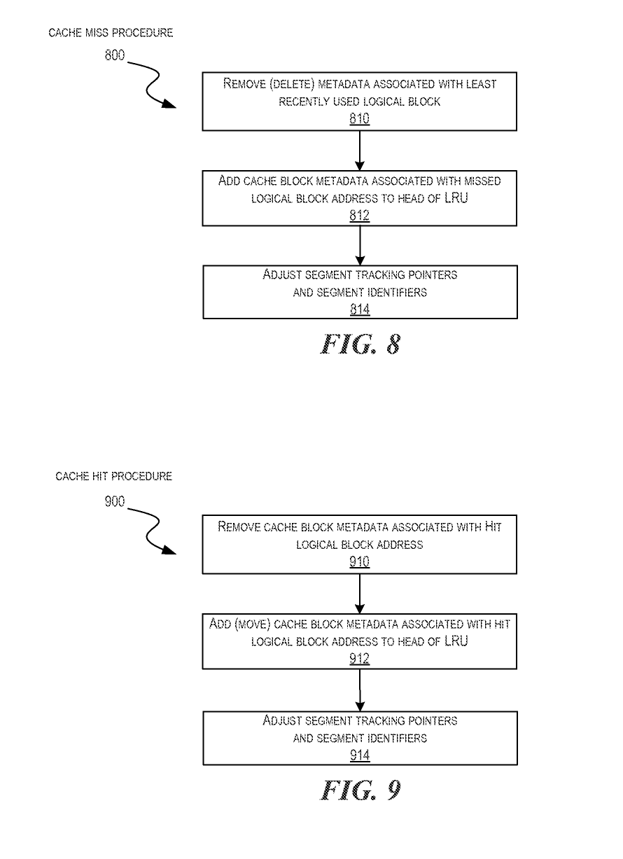

The storage system then, at stage 430 reads the requested read data from the read location or LBA on one or more of the HDD volumes 413 of the persistent storage subsystem 405 and, at stage 440, provides the requested data to the client responsive to the read request. Optionally, at stage 450, the storage system writes the read data to the secondary cache system (if it exists for the particular LBA). In some embodiments, the segmented metadata 409 utilizes a least recently used (LRU) based cache tracking mechanism with segment tracking pointers and segment identifiers added to the metadata structures. Examples implementing an LRU based cache tracking are illustrated and discussed in greater detail with respect to FIGS. 8-9 and FIGS. 10A-11B.

The example of FIG. 4B is similar to the example of FIG. 4A but illustrates a simulated cache hit. At stage 460 a client read (or host read) request directed to data persistently stored in the persistent storage subsystem 405 is received and processed by the storage system to determine a read location or logical block address (LBA) associated with the read request from which to read requested data. Responsive to the read request, at stage 420, the storage system checks the segmented metadata 409 to determine if the read data is stored on the simulated secondary cache 407 using the read location or LBA. As discussed above, while the simulated secondary cache 407 may not exist or may only exist in part, the segmented metadata can track the maximum configurable size of the simulated secondary cache 407.

In the example of FIG. 4B, at stage 470, the storage server reads, checks, and/or otherwise traverses or interrogates the segmented metadata 409 to determine that the read location or LBA associated with the received client request is indicated by the cache metadata and thus, a cache hit occurs. The storage system then determines on which of various cache sizes a cache hit would have occurred based on the segment in which the cache hit occurred. For example, a cache hit in the last segment of the segmented cache metadata 409 in may result in a cache hit only for the maximum supported (or simulated) cache size.

In some embodiments, the segmented metadata 409 is configured to utilize a least recently used (LRU) based cache tracking mechanism with segment tracking pointers and segment identifiers added to the metadata structures. The segments correspond to multiple cache sizes and the LRU is established to track the maximum cache size. As discussed above, each segment of the segmented cache metadata 409 corresponds to one or more of the various cache sizes for the cache system. Consequently, the storage system can determine on which of the various cache sizes the cache hit

In some embodiments, there need not be actual cache blocks corresponding to the secondary cache 407. That is, the secondary cache 407 can be simulated and the segmented metadata 409 can be used to simulate the predictive cache statistics while servicing data access requests using the persistent storage subsystem 405. Alternatively, the simulation can be run on the workload using a fraction of the maximum (simulated) secondary cache size.

Once the metadata is updated, the storage system can then record the cache hit for those various cache sizes that a cache hit would have occurred. At stage 481, the storage system reads the requested read data from the read location or LBA on one or more of the HDD volumes 413 of the persistent storage subsystem 405 or the secondary cache system 407 (flash-based system) depending on whether or not the data is available on the secondary cache system 407. As discussed, the secondary cache system 407 may be a simulated system and thus not exist in whole or in part. For example, the actual size of a secondary cache system 407 may be less than the simulated secondary cache system in which case some of the read data (even in the case of a cache hit) is not available on the secondary cache system 407 and thus is read from the HDD volumes 413 of the persistent storage subsystem 405.

Lastly, at stage 490, the storage system provides the requested data to the client responsive to the read request.

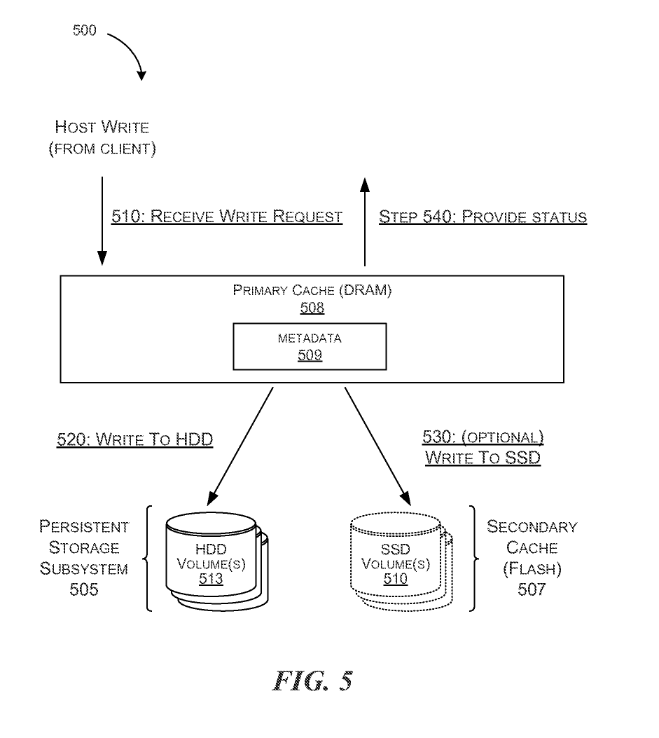

FIG. 5 is a block diagram 500 schematically illustrating technology for tracking a simulated secondary cache system 507 using cache block metadata 509 stored on a primary cache system 504. More specifically, FIG. 5 illustrates an example of tracking a simulated secondary cache system 507 using segmented cache block metadata 509 responsive to client-initiated write request.

In the example of FIG. 5, a storage server (not illustrated) such as, for example, storage server 108 of FIG. 1, includes a primary cache system 508 having segmented metadata 509 stored thereon for tracking simulated cache blocks of a secondary cache system 507 while performing a workload including a client-initiated read request (operation). The primary cache system 508 can be, for example, a dynamic random access memory (DRAM) and the secondary cache system 507 can be a flash read cache system including multiple SSD volumes 510.

At stage 511 a client write (or host write) request directed to the persistent storage subsystem 505 is received and processed by the storage system to determine a write location or logical block address (LBA) associated with the write request. Responsive to the write request, at stages 520 and 530, the storage system writes to the persistent storage subsystem 505 and optionally to the secondary cache 507, respectively. Lastly, at stage 540, the storage system provides a response or status that the write was successful.

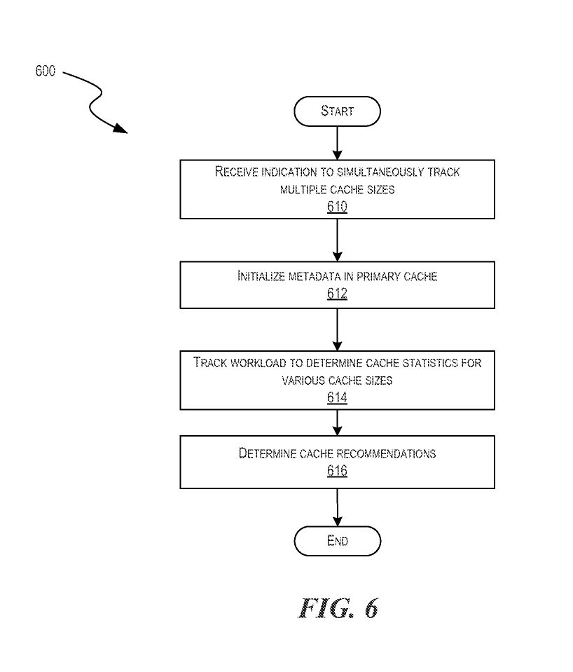

FIG. 6 is a flow diagram illustrating an example process 600 for generating predictive cache statistics for multiple cache sizes. A storage controller e.g., storage controller 200 of FIG. 2, among other functions, can perform the example process 600. In particular, an I/O tracking engine such as, for example, I/O tracking engine 224 of FIG. 2 and a predictive analysis engine such as, for example, predictive analysis engine 226 of FIG. 2 can, among other functions, perform process 600. The I/O tracking engine and the predictive analysis engine may be embodied as hardware and/or software, including combinations and/or variations thereof. In addition, in some embodiments, the I/O tracking engine and/or the predictive analysis engine can include instructions, wherein the instructions, when executed by one or more processors of a storage controller, cause the storage controller to perform one or more steps including the following steps.

In a receive stage, at step 610, the storage controller receives an indication to track multiple cache sizes. For example, the storage controller can receive an indication to track multiple cache sizes from an administrator seeking to determine an optimal flash-based cache size for a secondary cache system.

In an initialization stage, at step 612, the storage controller initializes the metadata in a primary cache. In a track stage, at step 614, the storage controller tracks an exemplary workload to determine cache statistics for various cache sizes. In a stage, at step 616, the storage controller processes the cache statistics to determine additional cache statistics and to determine optional cache recommendations. For example, the storage controller can process the hit ratios for each of the memories to determine an estimated average I/O response time, an estimated overall workload response time, an estimated total response time for the exemplary workload. This may be determined using known estimates for read response times of SSD (cache) vs. HDD.

In some embodiments, the storage controller can determine and/or provide characteristics of the workload (working data set) such as, for example, the size of the workload, cacheability of the workload (e.g., locality of repeated reads, whether cacheable or not), etc.

In some embodiments, the storage controller can also apply various caching algorithms to a workload. In this case, additional cache metadata or a second cache metadata can be utilized.

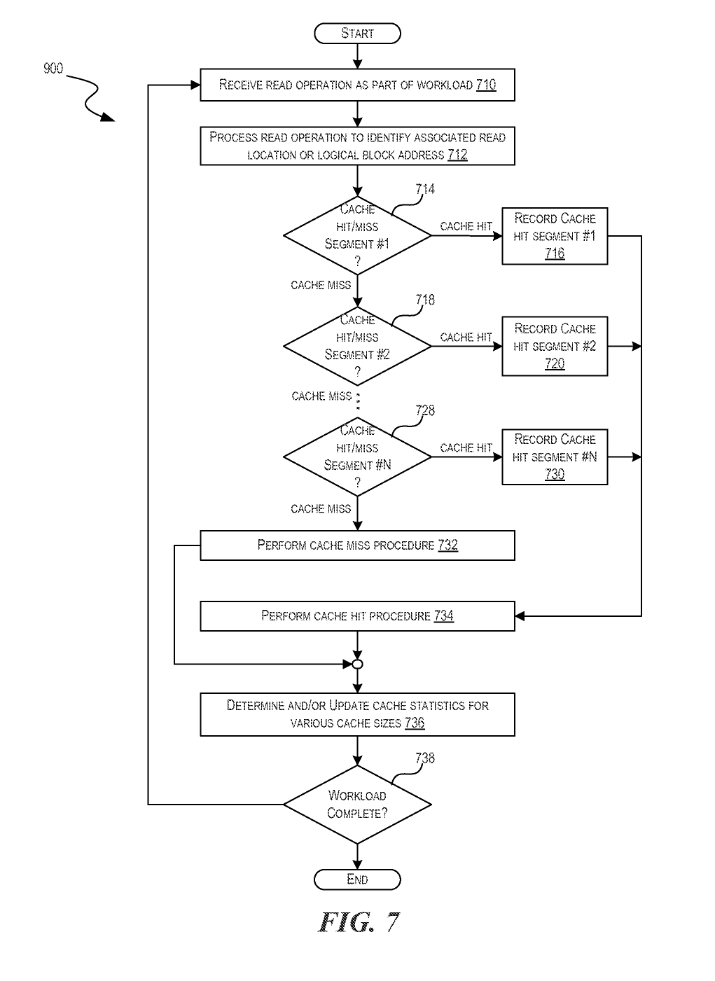

FIG. 7 is a flow diagram illustrating an example process 700 for tracking a workload (or working dataset) to determine cache statistics for various cache sizes. A storage controller e.g., storage controller 200 of FIG. 2, among other functions, can perform the example process 700. Specifically, an I/O tracking engine of a storage controller such as, for example, I/O tracking engine 224 of FIG. 2 can, among other functions, perform process 700. The I/O tracking engine may be embodied as hardware and/or software, including combinations and/or variations thereof. In addition, in some embodiments, the I/O tracking engine can include instructions, wherein the instructions, when executed by one or more processors of a storage controller, cause the storage controller to perform one or more steps including the following steps.

In receive stage 710, the storage controller receives a client-initiated read request as part of the workload (or working dataset). As discussed above, the workload can include various read and write requests (client-initiated I/O operations) that are received from client systems (or clients). In process stage 712, the storage controller processes the client-initiated read operation to identify a read location or LBA associated with the read request wherein the read location or LBA indicates a location from which the read request is attempting to read requested data.

In decision cache hit/miss stage 714, the storage controller determines if a first segment (segment #1) is a cache hit or miss. The storage system can make this determination by, for example, checking the segmented metadata (e.g., segmented metadata 409) to determine if the read data is stored on a simulated cache (e.g., secondary cache 407) for which the system is attempting to generate predictive cache statistics. If a cache hit is detected for segment #1, then it is recorded at stage 716. The process then continues on to a cache hit stage 734. Otherwise, if a cache miss is detected for segment #1, then the process continues on to the next decision cache hit/miss stage, stage 718.

In decision cache hit/miss stage 718, the storage controller determines if a second segment (segment #2) is a cache hit or miss. The storage system can make this determination in the same or similar manner to stage 714. If a cache hit is detected for segment #2, then it is recorded at stage 720. The process then continues on to a cache hit stage 734. Otherwise, if a cache miss is detected for segment #2, then the process continues on to the next decision cache hit/miss stage. This process continues for each segment of the cache metadata.

In decision cache hit/miss stage 728, the storage controller determines if a last segment of the cache metadata (segment #N) is a cache hit or miss. If a cache hit is detected for segment #N, then it is recorded at stage 730. The process then continues on to a cache hit stage 734. Otherwise, if a cache miss is detected for segment #N, then the read request is determined to be a cache miss for the entire segmented cache and continues on to a cache miss stage 732.

In cache miss stage 732, the storage controller performs a cache miss procedure. The cache miss procedure can vary depending on the cache tracking mechanism utilized by the storage controller. An example of a cache miss procedure for a LRU-based cache tracking mechanism with segment tracking pointers and segment identifiers added to the metadata structures is illustrated and discussed in greater detail with respect to FIG. 8.

In cache hit stage 734, the storage controller performs a cache hit procedure. Like the cache miss procedure, the cache hit procedure can also vary depending on the cache tracking mechanism utilized by the storage controller. An example of a cache hit procedure for a LRU-based cache tracking mechanism with segment tracking pointers and segment identifiers added to the metadata structures is illustrated and discussed in greater detail with respect to FIG. 9.

In a determination stage 736, the storage controller determines and/or updates cache statistics for the various cache sizes of the cache system. For example, the storage controller can update a hit ratio for each of the various cache sizes based on the segments that were marked as cache hits. Additionally, the storag

FIG. 8 is a flow diagram illustrating an example cache miss process 800 for generating predictive cache statistics for various cache sizes. Example process 800 is discussed primarily with respect to a LRU-based cache tracking mechanism, however, as discussed above, other cache tracking mechanisms can also be utilized.

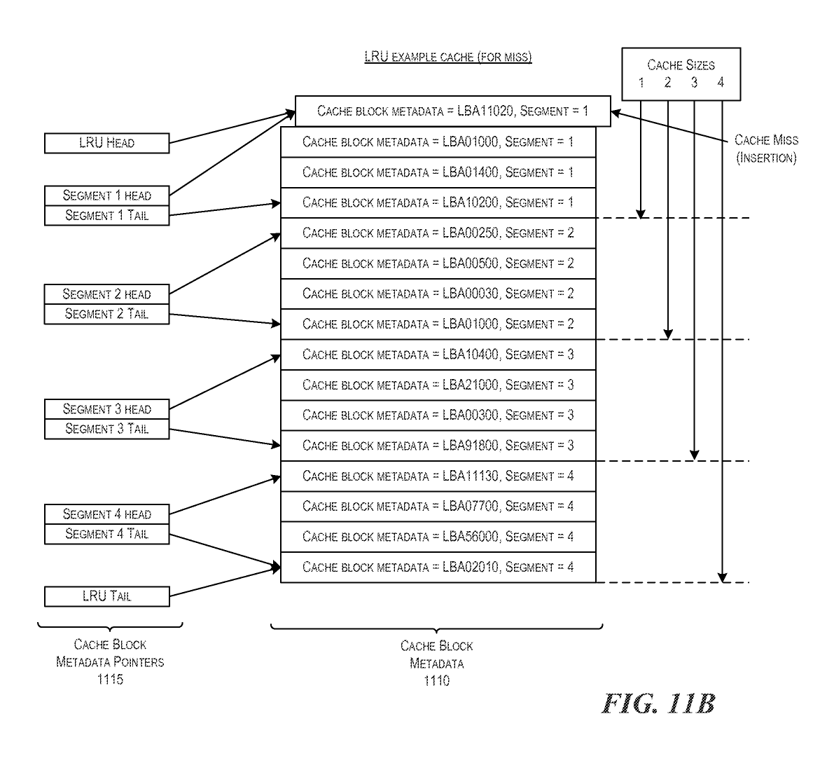

A storage controller e.g., storage controller 200 of FIG. 2, among other functions, can perform the example process 800. Specifically, an I/O tracking engine of a storage controller such as, for example, I/O tracking engine 224 of FIG. 2 can, among other functions, can perform process 800. The I/O tracking engine may be embodied as hardware and/or software, including combinations and/or variations thereof. In addition, in some embodiments, the I/O tracking engine can include instructions, wherein the instructions, when executed by one or more processors of a storage controller, cause the storage controller to perform one or more steps including the following steps. The example cache miss procedure 800 of FIG. 8 is described in conjunction with FIGS. 11A-11B which Illustrate example operation of a LRU-based cache tracking mechanism with segment tracking pointers and segment identifiers added to the cache block metadata.

Prior to executing example process 800, the storage controller has determined that a read request is a cache miss for the entire segmented cache and thus proceeds to the cache miss procedure 800. At a removal stage 810, the storage controller removes (deletes) a metadata cache block associated with the least recently used logical cache block. An example of this removal is illustrated in FIG. 11A. In some embodiments, removal occurs when all metadata cache blocks are in use. Otherwise a recycle operation occurs. That is, when all metadata cache blocks are not in use, some are in a “free” state (not assigned to an LBA). Initially, the cache is empty and all metadata cache blocks are in the “free” state. For a cache miss, a “free” metadata block is used first if available. Otherwise, a cache metadata block is recycled from the LRU.

At an addition stage 812, the storage controller adds a cache block metadata associated with the missed read request (or location or LBA) to the head of the cache block metadata. Lastly, at an adjustment stage 814, the storage controller adjusts the segment tracking points and/or segment identifiers. Stages 812 and 814 are illustrated and discussed in greater detail with reference to FIG. 11B.

FIG. 9 is a flow diagram illustrating an example cache hit process 900 for generating predictive cache statistics for various cache sizes. Example process 900 is discussed primarily with respect to a LRU-based cache tracking mechanism, however, as discussed above, other cache tracking mechanisms can also be utilized.

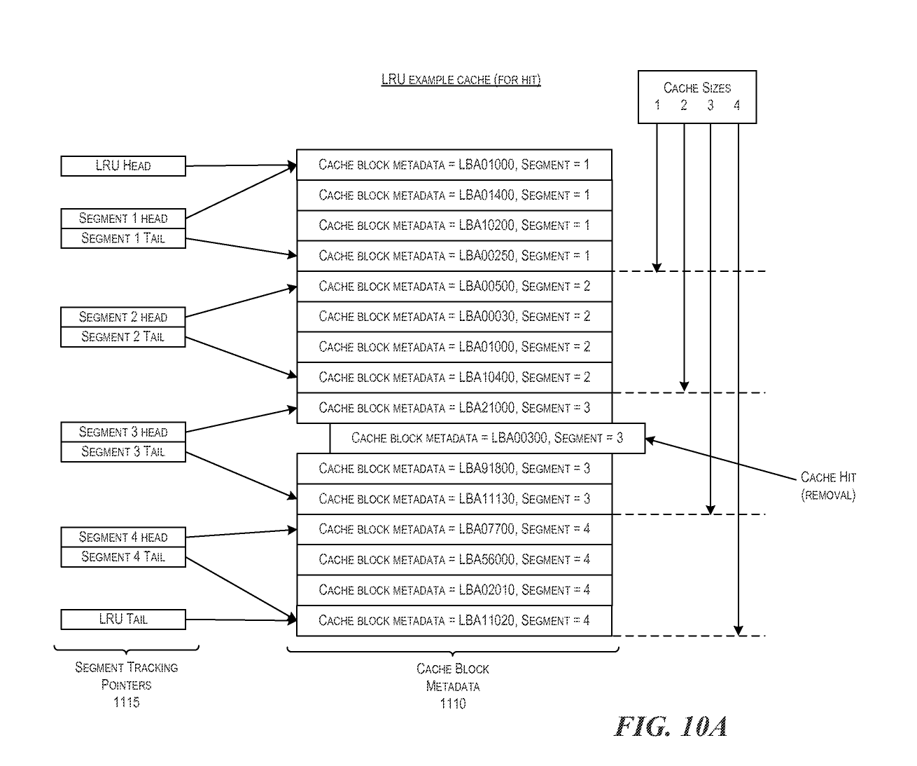

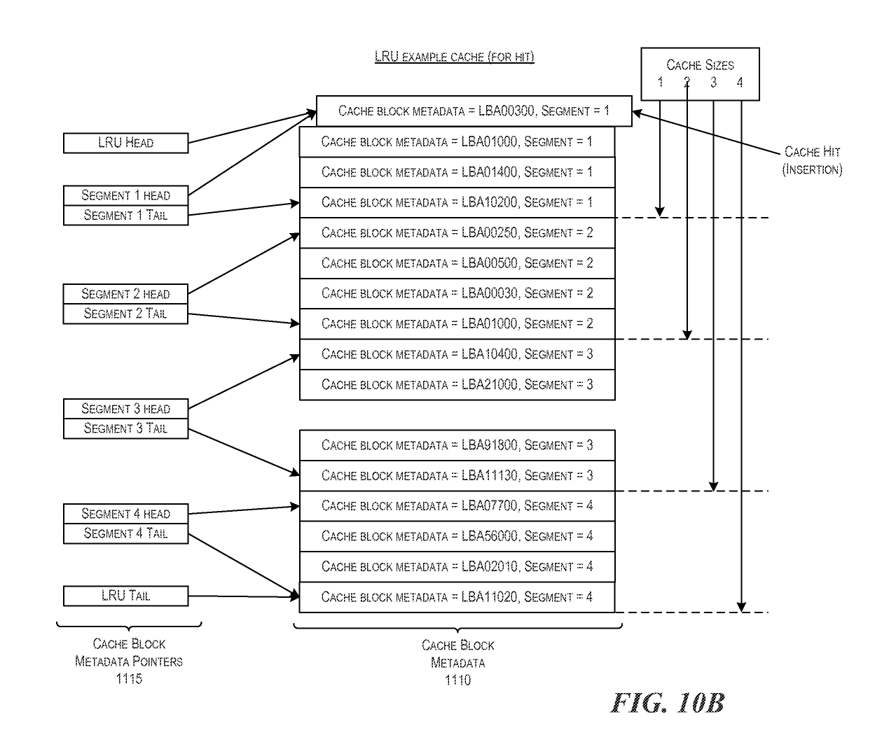

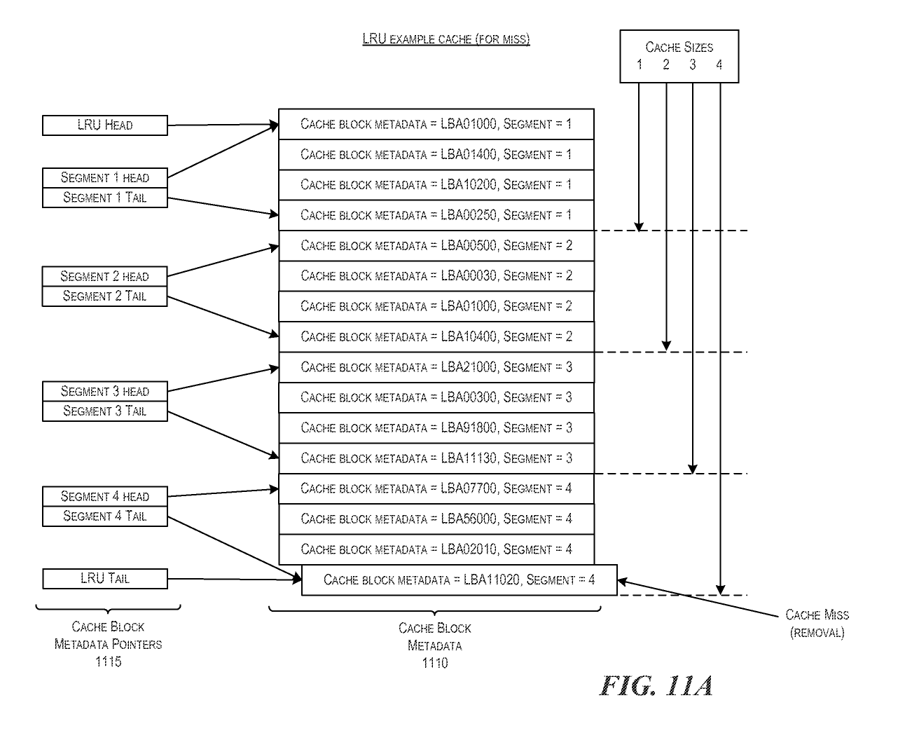

A storage controller e.g., storage controller 200 of FIG. 2, among other functions, can perform the example process 900. Specifically, an I/O tracking engine of a storage controller such as, for example, I/O tracking engine 224 of FIG. 2 can, among other functions, can perform process 900. The I/O tracking engine may be embodied as hardware and/or software, including combinations and/or variations thereof. In addition, in some embodiments, the I/O tracking engine can include instructions, wherein the instructions, when executed by one or more processors of a storage controller, cause the storage controller to perform one or more steps including the following steps. The example cache hit procedure 900 of FIG. 9 is described in conjunction with FIGS. 10A-10B which Illustrate example operation of a LRU-based cache tracking mechanism with segment tracking pointers and segment identifiers added to the cache block metadata.

Prior to executing example process 900, the storage controller has determined that a read request is a cache hit and thus proceeds to the cache hit procedure 900. At a removal stage 910, the storage controller removes the metadata cache block associated with the cache hit block. An example of this removal is illustrated in FIG. 10A. At an addition stage 912, the storage controller adds the removed cache block metadata associated with the cache hit to the head of the cache block metadata. Lastly, at an adjustment stage 914, the storage controller adjusts the segment tracking points and/or segment identifiers. Stages 912 and 914 are illustrated and discussed in greater detail with reference to FIG. 10B.

FIGS. 10A-10B and 11A-11B are block diagrams illustrating example operations of a LRU-based cache tracking mechanism prior to and subsequent to a cache hit and prior to and subsequent to a miss hit, respectively. The example includes cache block metadata 1110 having segment tracking pointers 1115 and segment identifiers added to the metadata structures. The storage system utilizes the segment tracking pointers 1115 and/or the segment identifiers to identify the various segments of the cache block metadata 1110.

As discussed herein, the segments correspond to various cache sizes. In the example of FIGS. 10A-11B, the segments correspond (or represent) four cache sizes, however, the segment tracking pointers 1115 and/or the segment identifiers can be configured to track any number of cache sizes. In the example of FIGS. 10A-11B, by way of example and not limitation, the cache block metadata 1110 is divided into four equal segments each comprising a percentage of the maximum supported (or simulated) cache size. Although the cache block metadata 1110 is divided into equal segments in the examples provided, he cache block metadata 1110 can be divided by the segments in any manner (including unequal segments) to properly simulate the various cache sizes. Additionally, in some embodiments, the various cache sizes simulated can be selectable and/or otherwise configurable.

Referring first to FIGS. 10A and 10B which illustrate example operations of a LRU-based cache tracking mechanism with segment tracking pointers and segment identifiers added to cache block metadata prior to and subsequent to a cache hit. In this example, a cache read is received and an associated read location or LBA associated with the read request from which to read requested data is determined. In some embodiments, the storage controller then traverses a linked list starting from the LRU head pointer to determine that the cache read is a hit on the simulated cache system. While traversing the LRU linked list, it is possible to find the cache block metadata. However, this technique can be slow due to the potentially very large number of metadata elements. In some embodiments, the look-up of the cache block metadata is done through the use of a hash table and a different linked list that that links cache block metadata together. Accordingly, in some embodiments, there can be two linked list elements in each cache block metadata, one linked list element for the LRU linked list and another linked list element for the hash table linked lists.

As illustrated in FIG. 10A, a cache hit is detected for “LBA00300” and the storage controller responsively removes the metadata block. Subsequently, as illustrated in FIG. 10B, the metadata block is inserted at the head of the cache block metadata 1110 and the cache block metadata pointers 1115 and segment identifiers are adjusted accordingly. In this example, the LRU head pointer and the segment 1 head pointer are moved from the “LBA01000” metadata block to the “LBA00300” metadata block and the segment identifier for the “LBA00300” metadata block is modified from segment 3 to segment 1; the segment 1 tail pointer is moved from the “LBA00250” metadata block to the “LBA10200” metadata block; the segment 2 head pointer is moved from the “LBA00500” metadata block to the “LBA00250” metadata block and the segment identifier for the “LBA00250” metadata block is modified from segment 1 to segment 2; the segment 2 tail pointer is moved from the “LBA10400” metadata block to the “LBA01000” metadata block; and the segment 3 head pointer is moved from the “LBA21000” metadata block to the “LBA10400” metadata block and the segment identifier for the “LBA104000” metadata block is modified from segment 2 to segment 3.

Referring next to FIGS. 11A and 11B which illustrate example operations of a LRU-based cache tracking mechanism with segment tracking pointers and segment identifiers added to cache block metadata prior to and subsequent to a cache miss. In this example, a cache read is received and an associated read location or LBA associated with the read request from which to read requested data is determined. The storage controller then traverses a linked list starting from the LRU head pointer to determine that the cache read is a miss on the simulated cache system. In some embodiments, the storage controller then traverses a linked list starting from the LRU head pointer to determine that the cache read is a hit on the simulated cache system. While traversing the LRU linked list, it is possible to find the cache block metadata. However, this technique can be slow due to the potentially very large number of metadata elements. In some embodiments, the look-up of the cache block metadata is done through the use of a hash table and a different linked list that that links cache block metadata together. Accordingly, in some embodiments, there can be two linked list elements in each cache block metadata, one linked list element for the LRU linked list and another linked list element for the hash table linked lists.

As illustrated in FIG. 11A, a cache miss is detected for “LBA11020” and the storage controller responsively removes the oldest metadata block LBA38400. Subsequently, as illustrated in FIG. 11B, the metadata block is changed from “LBA38400” to “LBA11020” and is inserted at the head of the cache block metadata 1110 and the cache block metadata pointers 1115 and segment identifiers are adjusted accordingly. In this example, the LRU head pointer and the segment 1 head pointer are moved from the “LBA01000” metadata block to the “LBA11020” metadata block and the segment identifier for the “LBA11020” metadata block is modified from segment 4 to segment 1; the segment 1 tail pointer is moved from the “LBA00250” metadata block to the “LBA10200” metadata block; the segment 2 head pointer is moved from the “LBA00500” metadata block to the “LBA00250” metadata block and the segment identifier for the “LBA00250” metadata block is modified from segment 1 to segment 2; the segment 2 tail pointer is moved from the “LBA10400” metadata block to the “LBA01000” metadata block; the segment 3 head pointer is moved from the “LBA21000” metadata block to the “LBA10400” metadata block and the segment identifier for the “LBA104000” metadata block is modified from segment 2 to segment 3; the segment 3 tail pointer is moved from the “LBA11130” metadata block to the “LBA91800” metadata block; the segment 4 head pointer is moved from the “LBA007700” metadata block to the “LBA11130” metadata block and the segment identifier for the “LBA11130” metadata block is modified from segment 3 to segment 4; and the segment 4 tail pointer and LRU tail pointer is moved from what was the “LBA38400” metadata block to the “LBA02010” metadata block.

The processes described herein are organized as sequences of operations in the flowcharts. However, it should be understood that at least some of the operations associated with these processes potentially can be reordered, supplemented, or substituted for, while still performing the same overall technique.

The technology introduced above can be implemented by programmable circuitry programmed or configured by software and/or firmware, or they can be implemented entirely by special-purpose “hardwired” circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware for implementing the technology introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

The term “logic”, as used herein, can include, for example, special-purpose hardwired circuitry, software and/or firmware in conjunction with programmable circuitry, or a combination thereof.

Although the disclosed technology has been described with reference to specific exemplary embodiments, it will be recognized that the technology is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method, comprising:
segmenting cache metadata so that each segment of the cache metadata corresponds to one or more of multiple cache sizes;
tracking, by a storage controller, simulated cache blocks of a cache system using the cache metadata while performing a workload including multiple client-initiated storage operations; and
determining concurrently, by the storage controller, predictive statistics for the multiple simulated cache sizes using the corresponding segments of the cache metadata.

2. The method of claim 1, wherein the cache metadata includes multiple segment identifiers for tracking the segments of the cache metadata.

3. The method of claim 1, wherein the simulated cache blocks of the cache system are tracked using a least recently used cache tracking mechanism.

4. The method of claim 1, wherein the simulated cache blocks of the cache system are tracked using a most recently used cache tracking mechanism.

5. The method of claim 1, further comprising:
receiving, by the storage controller, the workload including the multiple client-initiated storage operations.

6. The method of claim 1, wherein tracking further comprises:
processing a first client-initiated storage operation of the multiple client-initiated storage operations to determine if a cache hit occurs;
identifying the segment of the cache metadata on which the cache hit occurs; and
recording the cache hit with the corresponding segment.

7. The method of claim 1, wherein determining the predictive statistics includes determining a cache hit ratio for each of the variety of cache sizes.

8. The method of claim 1, further comprising:
initializing, by the storage controller, the cache metadata prior to performing the workload by:
identifying a maximum simulated cache size; and
segmenting the cache metadata for tracking multiple cache sizes up to the maximum simulated cache size.

9. The method of claim 8, further comprising:
receiving, by the storage controller, an indication to simultaneously track various secondary cache sizes.

10. The method of claim 8, wherein the maximum simulated cache size is a maximum cache size supported by the storage controller.

11. The method of claim 8, wherein the cache metadata is segmented in increments of five to twenty-five percent of the maximum simulated cache size.

12. A storage system, comprising:
a storage controller;
a network interface configured to receive a workload including multiple client storage operations;
a memory having stored thereon segmented cache metadata,
wherein the cache metadata is segmented such that each segment of the cache metadata corresponds to one or more of multiple cache sizes of the simulated cache system; and
wherein the storage controller is configured to:
track simulated cache blocks of a cache system using the segmented cache metadata while performing the workload, and
determine predictive statistics for the multiple simulated cache sizes using the corresponding segments of the cache metadata.

13. The storage system of claim 12, wherein the cache metadata includes multiple segment identifiers for tracking the segments of the cache metadata.

14. The storage system of claim 12, wherein the simulated cache blocks of the cache system are tracked using a least recently used cache tracking mechanism.

15. The storage system of claim 12, further comprising:
a persistent storage subsystem,
wherein one or more of the multiple client-initiated storage operations attempt to access data persistently stored on a memory subsystem.

16. The storage system of claim 12, wherein the memory comprises a primary cache system and the simulated cache system comprises a secondary cache system, and wherein the secondary cache system is a solid state cache system.

17. The storage system of claim 16, further comprising the secondary cache system.

18. The storage system of claim 12, wherein the predictive statistics include a hit/miss ratio for the multiple simulated cache sizes.

19. The storage system of claim 12, wherein the characteristics of the workload include estimated response times for the multiple simulated cache sizes.

20. The storage system of claim 12, wherein the predictive statistics include one or more characteristics of the workload.

21. A computer-readable storage medium storing instructions to be implemented by a storage controller having a processor, wherein the instructions, when executed by the processor, cause the storage controller to:
track simulated cache blocks of a cache system using cache metadata while performing a workload including multiple client-initiated storage operations,
wherein the cache metadata is segmented such that each segment of the cache metadata corresponds to one or more of multiple cache sizes; and
determine predictive statistics for the multiple simulated cache sizes using the corresponding segments of the cache metadata.
